(19) United States
(12) Patent Application Publication
(10) Pub. No.: US 2008/0193736 A1
(43) Pub. Date: Aug. 14, 2008

(54) Resin-impregnated porous filler

(76) Inventors: Katsuhiko Kikuchi, Tokyo (JP); Hiroshi Idei, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/987,518

(22) Filed: Nov. 30, 2007

(30) Foreign Application Priority Data
Dec. 1, 2006 (JP) P.2006-325663

(51) Int. Cl. B32B 3/26; B05D 5/00

(52) U.S. Cl. 428/306.6; 427/243

(57) ABSTRACT

A resin-impregnated porous filler having meso-pores, micro-pores, and macro-pores is obtained by inserting a coupling agent or an inorganic material between layers of a stratified clay mineral to prepare a crosslinked structure between the layers; making the stratified clay mineral three-dimensional; and impregnating the macro-pores with resin.

This application claims foreign priority from Japanese Patent Application No. 2006-325663 filed on Dec. 1, 2006, the entire contents of which are hereby incorporated by reference.

### BACKGROUND OF THE INVENTION

1. Field of the Invention

The present invention relates to a resin-impregnated porous filler having macro-pores, meso-pores, and micro-pores. Specifically, the present invention relates to a porous filler for use as friction materials for brakes of automobiles, railcars and industrial equipments, a structural adhesive, structural members for architecture such as concrete, and compounding ingredient of composite materials of plastics and the like.

2. Related Art

In order to prevent a noise at braking time, a raw ingredient of a friction material may include stratified materials, zeolite and the like having high water absorption, as friction ingredients or friction modifier ingredient. For example, JP-B2-2867661 discloses, as a friction material capable of effectively restraining squeal at braking time while maintaining the braking force, a friction material including a thermosetting resin containing a fibrous component and inorganic granules having a planar crystal structure such as mica, talc, and the like, and a manufacturing method of the friction material.

JP-B2-2827140 discloses, as a friction material well restrained in the squeal at braking time and excellent in fading resistance and wear resistance, a friction material containing a fibrous component, a thermosetting resin component, and vermiculite coated with a resin as the filler powder component. Further, JP-A-2000-038571 discloses, as a brake pad for automobiles capable of preventing generation of a noise what is called creep groan (a sound like growl), a non-asbestos brake pad for automobiles containing a fiber base material, a binder, and zeolite having a high water absorbing property as the friction modifier.

In recent years, a porous stratified clay mineral obtained by inserting organic ions, inorganic ions, sol particles, or a coupling agent and the like into a stratified clay mineral, and forming pores between layers has been attracting public attention as a novel porous functional filler. As compared with the clay mineral of the raw ingredient, this material has a greater specific surface area and pore volume and is improved in heat resistance and adsorption activity. Therefore, industrial use of the material has been tried as functional materials such as a thickener of a pigment such as oil paint, a modifier of a rubber composition, and composite materials equipped with characteristics of photochromism and electromism by an introduction of a catalyst, an adsorbent, an ion exchanger, or an electron-donating compound between layers.

Since porous functional fillers prepared from stratified clay minerals have high lubricating ability due to their layer structure, the use of the porous functional fillers in the friction material of vehicles where phenolic resins are compounded is examined. However, when a porous functional filler having macro-pores is simply blended in a raw ingredients of a friction material and subjected to compression molding by high pressure in thermoforming, the macro-pores are crushed before the resin enters into the porous functional filler, so that the reinforcing effect of the porous functional filler may not be sufficiently revealed. Further, since porous functional fillers are high in swelling characteristic by humidification so that lubricating ability and mechanical characteristics thereof are susceptible to the influence of humidity, porous composite materials are not yet generally utilized as the compounding material of the friction material for brakes.

As described above, porous composite materials manufactured with stratified clay minerals as the starting materials are susceptible to the influence of humidity, and when the materials are compounded and compression molded, macro pores are crushed and deformed, so that the strength of the formed product lowers or dimensional stability cannot be maintained. In particular, in the friction materials for brakes of vehicles compounded with these materials, a friction coefficient is liable to fluctuate by the influence of humidity, and wear resistance cannot be secured.

### SUMMARY OF THE INVENTION

One or more embodiments of the present invention provide a porous functional filler as a compounding ingredient of composite materials capable of using as friction materials for brakes, structural adhesive, structural members for architecture such as concrete, and molding materials of plastics, and having characteristics such as high mechanical strength at the time of compression molding, and low humidity dependency.

In accordance with one or more embodiments of the present invention, a resin-impregnated porous filler having meso-pores, micro-pores, and macro-pores is obtained by manufacturing a product having a crosslinked structure between layers of a stratified clay mineral by inserting a coupling agent or an inorganic material between the layers to make the stratified clay mineral three-dimensional, and the macro-pores of the porous filler are impregnated with resin.

In the resin-impregnated porous filler, the resin may comprise phenolic resin.

In the resin-impregnated porous filler, the resin may comprise liquid resin, and the liquid resin may be crosslinked with a curing agent or self-crosslinked when the porous filler is impregnated with the liquid resin or after the impregnation.

In one or more embodiments of the present invention, when a molded product is formed with a resin-impregnated porous filler obtained by impregnating a porous functional filler with resin (thermoplastic resin and thermosetting resin), a strength characteristics of the molded product are improved. Further, by impregnating macro-pores with resin, anchor effect is shown and strength characteristics are improved when a load is applied to the molded product.

In addition, when an organized stratified clay mineral obtained by inserting a coupling agent between layers of a stratified clay mineral having swelling ability and impregnating with resin is used as a lubricating material, the resin-impregnated filler is hydrophobitized by the coupling agent inserted between layers, so that swelling characteristic vanishes and a fluctuation of characteristics due to humidity diminishes.

Other aspects and advantages of the invention will be apparent from the following description and the appended claims.

### BRIEF DESCRIPTION OF THE DRAWINGS

FIG. 1 is a view typically showing a resin-impregnated porous filler, which shows that the macro-pore of the porous functional filler is impregnated with resin.

FIG. 2 is a view typically showing a porous functional filler.

### DETAILED DESCRIPTION OF THE EXEMPLARY EMBODIMENTS

A porous functional filler used as a starting material in an exemplary embodiment of the invention is, as a precise structure is typically shown in FIG. 2, porous filler 5 including a stratified clay mineral 1 inserted with organic or inorganic compound 2 between layers and having macro-pores 3, meso-pores and micro-pores 4.

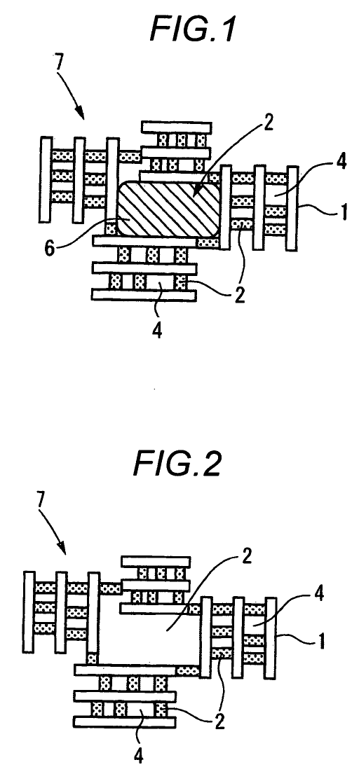

On the other hand, when a porous functional filler is used as the compounding ingredient of a composite material, resin-impregnated porous filler 7 in the exemplary embodiment is, as typically shown in FIG. 1, a porous functional filler obtained by impregnating macro-pore 3 of the above porous functional filler with resin 6 in advance.

A percentage of macro-pores in the porous functional filler may differ according to uses, but it is preferable that the percentage is from 20 to 90% in all pores, and more preferable from 40 to 70%. Further, for securing a strength of a molding material, it is preferred to use a porous functional filler having a pore size of macro-pores of from 0.1 to 50 μm and a pore size of micro-pores of from 0.5 to 10 μm. When the percentage of macro-pores and the pore sizes are out of the above ranges, the strength of the obtained composite material may lower and an effect of filler may be lost.

What may be used as materials of porous functional filler are primarily stratified clay minerals, e.g., silicate minerals having a stratifying structure, which are substances having the stratifying structures of the lamination of tetrahedron composed of silicic acid, octahedron containing Al, Mg, and the like. As such materials, e.g., montmorillonite, saponite, hectorite, beidellite, stibensite, nontronite, vermiculite, halloysite, mica, fluorinated mica, kaolinite, pyrophyllite are exemplified. These may be natural products or synthesized products. Further, zirconium phosphate, and swellable mica treated with fluorine may also be used. These compounds may be used alone, or two or more kinds may be used in combination. Of these stratified inorganic compounds, montmorillonite, saponite, hectorite, and fluorinated mica are preferably used. An aspect ratio of the compounds is preferably 10 or more, and more preferably from 20 to 500.

A porous functional filler using the above materials may be manufactured by making a thin layered plate-like particles three-dimensional to obtain a porous functional filler that is hydrophobic and having macro-pores, meso-pores, and micro-pores.

One manufacturing method of manufacturing a porous functional filler as a composite material includes reacting of a stratified clay mineral dispersed in a solvent or a colloid solution of stratified clay mineral powder and a precursor of an inorganic matter at room temperature or at heating condition to prepare a product having a crosslinking structure between layers containing the stratified clay mineral and the inorganic matter, and making the thin layered plate-like particles three-dimensional.

As the above sol (colloid) solution of the inorganic matter precursor, solutions of organic compounds such as alkoxide of one or more metals and semi-metals selected from Si, Ti, Zr, Sn, Ge, Al, B, Fe, Ga, P, V, Y, As, Sc, Cr, Nb, Mo, Ca, Mg, Pb, Sr, Zn, Cu, Ni, Co, Mn, Be and Ba, or inorganic salts thereof, a halogen compound dissolved or dispersed in one kind of inorganic or organic solvent, or in a mixed solvent of two or more of these solvents, or the one obtained by hydrolysis through aging after dissolution or dispersion may be used.

Specifically, for example, by suspending the stratified clay mineral in an inorganic alkoxy compound and mixing, the inorganic alkoxy compound is brought into contact with the stratified clay mineral and introduced between layers where quaternary ammonium ions are inserted. Treatment temperature is from room temperature to 100° C. or so. Thus, the inorganic alkoxy compound is hydrolyzed to generate a corresponding hydroxide, which is then condensed by hydrolysis, and inorganic oxide fine particles having alkyl groups bonded to the surfaces thereof are formed. Subsequently, a liquid is removed from the formed product, dried and baked. Inorganic oxide is formed between layers by the baking.

As another example, after dispersing a stratified clay mineral in water and controlling pH, a silane coupling agent in an amount of from 0.01 to 30 mass % based on the clay, preferably from 0.1 to 15 mass %, is dissolved in an organic solvent such as methanol, ethanol, isopropyl alcohol, acetone, tetrahydrofuran, ethylene glycol, acetonitrile, or acetic acid, or a mixed solvent of these organic solvents, the resulting solution is projected into the above dispersion, and stirred with heating. The heating temperature is the range of from room temperature to 80° C. After that, the reaction mixture is filtered, washed with water, and dried to obtain an organized stratified clay mineral.

The swelling characteristic of the obtained product by humidification vanishes by the insertion of the coupling agent between layers of the stratified clay mineral, so that the fluctuation of characteristics due to humidity diminishes. In addition, the distance of base of the stratified clay mineral extends by the insertion of the coupling agent and lubricating ability heightens.

In the exemplary embodiment, inorganic salts or organic salts of Si, Al, or Ti, or organic compounds in which alkoxide has one or more hydrophobic groups may be used as the coupling agents. However, generally used coupling agents for surface treatment may be used. For example, silane coupling agents, titanate coupling agents, and alumina coupling agents are exemplified.

The silane coupling agent is preferably a silane coupling agent represented by YₙSiX₄₋ₙ, where n is an integer of from 0 to 3; and Y represents a hydrocarbon group having from 1 to 25 carbon atoms, or an organic functional group consisting of a hydrocarbon group having from 1 to 25 carbon atoms and a substituent. The substituent contains at least one functional group selected from the group consisting of an ester group, an ether group, an epoxy group, an amino group, a carboxyl group, a carbonyl group, an amido group, a mercapto group, a sulfonyl group, a sulfenyl group, a nitro group, a nitroso group, a nitryl group, a halogen atom, and a hydroxyl group. X represents a hydrolyzable group and/or a hydroxyl group, and the hydrolyzable group is at least one group selected from the group consisting of an alkoxyl group, an alkenyloxy group, a ketoxime group, an acyloxy group, an amino group, an aminoxy group, an amido group, and halogen. Y of n number and X of 4-n number may be the same or different.

In the above, the hydrocarbon group means a straight chain or branched (i.e., having side chains), saturated or unsaturated, monovalent or polyvalent aliphatic hydrocarbon group, aromatic hydrocarbon group, or alicyclic hydrocarbon group, e.g., an alkyl group, an alkenyl group, a phenyl group, a naphthyl group, a cycloalkyl group and the like are exemplified. Incidentally, the alkyl group includes a polyvalent hydrocarbon group such as an alkylene group, etc., unless otherwise indicated. Similarly, the alkenyl group, alkynyl group, phenyl group, naphthyl group and cycloalkyl group respectively include an alkenylene group, an alkynylene group, a phenylene group, a naphthylene group, and a cycloalkylene group.

In the above formula YₙSiX₄₋ₙ, the examples of the hydroxyl groups having from 1 to 25 carbon atoms represented by Y include a group having a polymethylene chain such as decyltrimethoxy-silane, a group having a lower alkyl group such as methyltrimethoxysilane, a group having an unsaturated hydrocarbon group such as 2-hexenyltrimethoxysilane, a group having a side chain such as 2-ethylhexyltrimethoxysilane, a group having a phenyl group such as phenyltriethoxysilane, a group having a naphthyl group such as 3-β-naphthylpropyl-trimethoxysilane, and a group having a phenylene group such as p-vinylbenzyltrimethoxysilane. As the examples of the case where Y is a group having a vinyl group, vinyltrimethoxysilane, vinyltrichlorosilane, and vinyltriacetoxysilane are exemplified. As the examples of the case where Y is a group having an amino group, γ-aminopropyltrimethoxysilane, γ-(2-aminoethyl)aminopropyltrimethoxysilane, and γ-anilinopropyltrimethoxysilane are exemplified. The examples of representative silane coupling agents include 3-aminopropyltriethoxysilane, phenyltrimethoxysilane, vinyltrichlorosilane, and triethoxymethylsilane.

Solvents for dispersing a stratified clay mineral are inorganic or organic solvents of one kind alone, or mixed solvents of two or more kinds thereof. Any of acidic, neutral and alkaline solvents can be used. As a preferred solvent, ethanol is exemplified from the points of safety of working environment and inexpensiveness.

In impregnating a porous functional filler with resin, for the purpose of impregnating macro-pores of the pores of the porous functional filler, the kinds of resins and solvents have a great influence, but it is thought that the viscosity of the resin solution has the greatest influence. The viscosity of the resin solution is related to the concentration of the resin, so that it is preferred to experimentally find the optimal concentration of the resin of the resin solution after determining the kinds of resin and solvent. Since resin solutions generally have high viscosity, it is easy to impregnate macro-pores alone with resins.

The thermoplastic resins for use in the impregnation of the porous functional filler of the invention are not especially restricted. For example, polystyrene, polyisoprene, polybutadiene, butyl rubber, halogenated butyl rubber, polyurethane rubber, epichlorohydrin rubber, polyvinyl toluene, polyethylene butyrate, polyamide, methyl polymethacrylate, butyl polyacrylate, polycarbonate, polyimide, polymethylpentene, polyisobutylene, cycloolefin polymer, polyvinyl acetate, polyalkylene oxide, polyurethane, polyether sulfone, polysiloxane, polyphenylene sulfide, etc., are exemplified.

The thermosetting resins are also not restricted, and phenolic resins (including straight phenolic resin, various modified phenolic resins by rubber, etc.), urea resins, urea/melamine resins, melamine resins, epoxy resins, unsaturated polyester resins, etc., may be exemplified. Of these resins, phenolic resins and epoxy resins are preferred. Further, relatively low molecular weight resins such as butyl rubber and halogenated butyl rubber that are thermoplastic elastomers are also preferably used for the reason that the conditions of impregnation may be easily set.

The phenolic resins may be either a resol type or a novolak type.

Almost all the kinds of liquid resol type phenolic resins may be used so long as they are obtained by well-known means. As the phenols, phenol, cresol, xylenol, butylphenol, octylphenol, nonylphenol, phenylphenol, cyclohexylphenol, bisphenol A, bisphenol F, bisphenol S and the like may be used, and they may be used alone, or two or more kinds may be used as a mixture. Further, phenolic resins modified according to known methods such as oil-modification and rubber-modification may also be used. As aldehydes, formaldehyde, paraformaldehyde, benzaldehyde, etc., may be used alone or as mixtures of two or more kinds. As catalysts, known catalysts such as sodium hydroxide, potassium hydroxide, calcium hydroxide, barium hydroxide, zinc acetate, ammonia, and primary to tertiary amines such as hexamine may be used.

As solvents, either water or organic solvents may be used so long as they dissolve resol type phenolic resins. As the organic solvents, alcohols, e.g., methanol, ethanol, isopropyl alcohol, butanol, etc., ketones, e.g., acetone, methyl ethyl ketone (MEK), methyl isobutyl ketone, etc., and cellosolves are preferably used, but the solvents are not restricted thereto. Two or more kinds of the solvents may be used as a mixed solvent.

With respect to resol type resins, relatively many kinds of solvents may be selected as the solvents for resins, so that impregnation treatment is easily performed. Further, since resol type resins have self-crosslinking ability, when crosslinking is performed after impregnation treatment, the macro-pores of the filler solidify and dimensional stability is improved against compression deformation.

Novolak type phenolic resins may also be used for impregnation similarly to resol type resins, but the kinds of the solvents for impregnation are a little restricted. Phenolic resin impregnated into a filler is preferably cured with a curing agent, such as hexamethylenetetramine.

The examples of epoxy resins that may be used include bisphenol A type epoxy resins obtained by condensation reaction of epichlorohydrin and polyhydric phenols such as bisphenols or polyhydric alcohols, brominated bisphenol A type epoxy resins, biphenyl type epoxy resins, naphthalene type epoxy resins, glycidyl ether type epoxy resins such as ortho-cresol novolak type epoxy resins, glycidyl ester type epoxy resins obtained by condensation of epichlorohydrin and carboxylic acid, and heterocyclic epoxy resins such as hydantoin type epoxy resins obtained by the reaction of triglycidyl isocyanate or epichlorohydrin and hydantoins.

When epoxy resin is used, it is preferred to add a curing agent during or after the impregnation treatment to harden the resin in the macro-pores. Amine-based curing agents may be used as the curing agent. Acid anhydride series curing agents are also known as the curing agents for epoxy resins. However, networks of bonding formed in the epoxy resin hardened with an acid anhydride series curing agent are composed of ester bonds, or ester bonds and ether bonds, and such networks are attended with the possibility of causing hydrolysis. Therefore, amine-based curing agents are preferred from the aspect of water resistance. The specific examples of amine-based curing agents include ethylenediamine, diethylenetriamine, triethylenetetramine, tetraethylenepentamine, hexamethylenediamine, trimethylhexamethylenediamine, metaxylylenediamine, metaphenylenediamine, diaminodiphenylmethane, etc.

Butyl series rubbers such as butyl rubber and halogenated butyl rubber that are thermoplastic elastomers may also be used as resins for impregnation. In this case, after a liquid polymer having a number average molecular weight of 500 to 3,000 or so is impregnated into a porous filler, when the resin is hardened with a vulcanization accelerator, working efficiency of impregnation process is heightened.

Solvents for use in impregnation of resin are not especially restricted, and solvents containing proton donors and polar solvents may be used. For example, the examples of solvents include water, alcohols, e.g., methanol, ethanol, propanol, isopropanol, MEK, diethylene glycol, ethylene glycol, propylene glycol, ethylene glycolmonoethyl ether, ethylene glycol diethyl ether, ethylene glycol monoacetylate, ethylene glycol diacetylate, polyethylene glycol, polypropylene glycol, etc.; amides, e.g., formamide, dimethylformamide, etc.; aromatic hydrocarbons, e.g., benzene, toluene, xylene, etc.; aliphatic hydrocarbons, e.g., cyclohexane, n-hexane, n-tetradecane, etc.; ketones, e.g., tetrahydrofuran, acetone, methyl ethyl ketone, methyl isobutyl ketone, etc.; halogenated hydrocarbons, e.g., chloroform, dichloromethane, etc.; tetrahydrofuran, ethyl acetate, etc. These solvents may be used one kind alone, or two or more solvents may be used as a mixture. When water and alcohols may be used, the operation of impregnation becomes easy.

For impregnating operation of thermoplastic resin or thermosetting resin into a porous functional filler, a solvent and a filler in a mixed state, or resin in the state of being dissolved in a solvent in advance, is projected into a stirrer. For efficiently performing impregnation, it is recommended to disperse filler particles in a solvent containing resin dissolved therein. Accordingly, selection of the good solvent of the resin is the essential point of impregnation operation. Impregnation temperature is not especially restricted, and the operation can be performed within the range of from room temperature to the temperature not exceeding the boiling point of the solvent. When resin is impregnated, a surfactant may be added for achieving good wetting of the porous filler.

The prescription of impregnation is also not especially restricted, and a solvent in an amount of from 2 to 40 mass parts, preferably from 4 to 20 mass parts, based on 1 mass part of the porous functional filler and 1 mass part of the resin is mixed. When the amount of the solvent exceeds 40 mass parts, the processing efficiency of an obtained resin-impregnated functional filler in dehydrating and drying processes lowers, while the impregnation efficiency also lowers if the amount of the solvent is too little.

It is preferred that a porous filler impregnated with resin is granulated by pulverization for achieving uniform mixing and stirring in mixing and molding processes. The average major axis length of the granulated product is from 0.02 to 7 mm, and preferably from 0.03 to 5 mm. When the average major axis length is less than 0.02 mm, kneading of the compounding materials is difficult, while when the length exceeds 7 mm, entering into an extruder is deteriorated, which leads to dispersion failure.

The thus obtained resin-impregnated porous filler is greatly reduced in humidity dependency and improved in mechanical strength against compression deformation, so that it is used as the friction materials for brakes of railcars, structural adhesive, structural members for architecture such as concrete, and compounding ingredient of plastics.

When a friction material for brake is manufactured with the resin-impregnated porous filler as the composite material, a fibrous base material, an inorganic filler, a friction modifier and a binder are compounded. The resin-impregnated porous functional filler including a stratified clay mineral as the raw ingredient may be used as the inorganic filler in combination with metal particles such as copper, aluminum, zinc, etc., scaly inorganic substances such as vermiculite, mica, etc., and particles of barium sulfate, calcium carbonate, etc.

Further, when the binder compounded in the friction material for brake is the same as the impregnation resin of the filler, a process of eliminating the resin on the surface of the filler after preparation of the resin-impregnated porous filler is unnecessary, so that the manufacturing costs of the resin-impregnated porous filler is reduced.

A friction material may be manufactured according to known manufacturing processes. For example, a friction material may be manufactured through the processes of preforming, thermoforming, heating and polishing. In the case of the manufacturing process of a friction pad for a disc brake, a pressure plate is formed to a prescribed form by plate press, subjected to degreasing treatment and primer treatment, and coated with an adhesive, and a preformed product is formed by blending fiber base materials such as heat resisting organic fiber, inorganic fiber, metallic fiber, etc., and powder materials such as inorganic and organic packing materials, a friction controlling material, a thermosetting resin binder, etc., stirring these materials sufficiently homogeneously, and molding (preforming) the thoroughly stirred product at ordinary temperature by prescribed pressure. The thus produced both members are firmly affixed as one body by thermoforming at prescribed temperature and pressure, and the obtained product is subjected to after cure and final finishing treatment.

### Example

The exemplary embodiments of the invention will be described more specifically with reference to examples, but the invention should not be construed as being restricted thereto.

### Examples 1 and 2, and Comparative Examples 1 to 3

### Preparation of Porous Functional Filler

Dispersion of synthetic fluorine mica was prepared by projecting 10 g of synthetic fluorine mica and 15 g of acetic acid into 600 ml of distilled water, and thoroughly stirring. Twenty (20) grams of triethoxymethylsilane was diluted with 300 ml of ethanol and stirred thoroughly, the solution was thrown into the dispersion of synthetic fluorine mica, stirred at 75° C. for 5 hours with concentrating, and then subjected to heat treatment in a furnace at 200° C. for 2 hours, and porous functional filler A for use in the invention was obtained through pulverizing treatment.

Porous functional filler B was prepared in the same manner as above except for using triethoxyaminopropylsilane in place of triethoxymethylsilane.

### <Manufacture of Sample>

Fifteen (15) grams of porous functional filler A, 15 g of phenolic resin, and 100 ml of ethanol were put into a reaction vessel and sufficiently stirred at 70° C. The mixed solution was dried under reduced pressure at 80° C. for 72 hours, and Sample A of resin-impregnated porous filler was obtained through pulverizing treatment. Sample B of resin-impregnated porous filler was obtained in the same manner by using porous functional filler B.

### <Measurement of Sample>

The manufactured samples and porous functional fillers were measured for the distance of base by X-ray diffraction of powder. Further, in the prescription of compounding in Table 1 below, a product having a size of 50 mm×65 mm×10 mm was formed by the application of pressure of 30 MPa. A test piece was prepared from the product by cutting to a prescribed size, and strength characteristics were evaluated.

The distances of base of the manufactured samples and porous functional fillers measured by X-ray diffraction of powder are shown in Table 2 below. Samples A and B respectively have the same or more base distances as those of porous functional fillers A and B. Incidentally, in the following Tables, “methylsilane” means “triethoxymethylsilane”, and “aminopropylsilane” means “triethoxyaminopropylsilane”.

The results of the strength test of the test pieces formed according to the compounding prescription in Table 1 and by cutting are shown in Table 3 below. The samples in Examples 1 and 2 are higher in bending strength as compared with the samples in Comparative Examples 1 to 3, thus the effect of the invention is confirmed.

TABLE 1
Prescription of Compounding (mass parts)

| | | Comparative | Comparative |
|---|---|---|---|
| Raw ingredients | Example 1 | Example 1 | Example 2 |
| Barium sulfate | 80 | 80 | 90 |
| Porous filler | — | 10 | — |
| Phenolic resin | — | 10 | 10 |
| Sample (resin-impregnated | 20 | — | — |
| porous filler) | | | |

TABLE 2
Results of X-Ray Diffraction Test of Powder

| | Distance |
|---|---|
| | of Base |
| Sample Name | (nm) |
| Sample A (resin-impregnated porous filler) (methyl | 1.54 |
| silane) | |
| Porous filler A (methyl silane) | 1.48 |
| Synthetic fluorine mica | 0.96 |
| Sample B (resin-impregnated, aminopropylsilane) | 2.01 |
| Porous filler B (aminopropylsilane) | 1.97 |

TABLE 3
Results of Strength Test of Test Pieces

| | Bending |
|---|---|
| | Strength |
| Sample Name | (MPa) |
| Example 1 (methylsilane) | 59.2 |
| Comparative Example 1 (methylsilane) | 55.9 |
| Comparative Example 2 | 37.6 |
| Example 2 (aminopropylsilane) | 59.1 |
| Comparative Example 3 (aminopropylsilane) | 62.6 |

The test results of the test pieces formed by the prescription of compounding in Table 1 are shown in Table 3. The samples in Examples are higher in bending strength as compared with bending strengths of the samples in Comparative Examples, thus the effect of the invention is confirmed.

Since the resin-impregnated porous fillers in the exemplary embodiment of the invention have characteristic of low humidity dependency and high in mechanical strength at the time of formation, it is thought that the range of use of the resin-impregnated porous fillers of the invention will extend to the fields of friction materials for brakes of automobile, railcar, aircraft and industrial equipments, structural adhesive, structural members for architecture such as concrete, and molding materials of plastics and the like.

### DESCRIPTION OF REFERENCE NUMERALS

1: Stratified clay mineral
2: Inorganic material
3: Macro-pore
4: Meso-pore, micro-pore
5: Porous functional filler
6: Resin
7: Resin-impregnated porous filler

What is claimed is:

1. A resin-impregnated porous filler, obtained by inserting a coupling agent or an inorganic material between layers of a stratified clay mineral to prepare a crosslinked structure between the layers; and making the stratified clay mineral three-dimensional, the resin-impregnated porous filler comprising:
meso-pores, micro-pores, and macro-pores; and
resin impregnating in the macro-pores.

2. The resin-impregnated porous filler according to claim 1, wherein the resin comprises phenolic resin.

3. The resin-impregnated porous filler according to claim 1, wherein the resin comprises liquid resin, and
the liquid resin is crosslinked with a curing agent or self-crosslinked when the porous filler is impregnated with the liquid resin or after the impregnation.

4. A method of manufacturing a resin-impregnated porous filler, the method comprising:
inserting a coupling agent or an inorganic material between layers of a stratified clay mineral to prepare a crosslinked structure between the layers;
making the stratified clay mineral three-dimensional to obtain a porous filler having meso-pores, micro-pores, and macro-pores; and
impregnating the macro-pores with resin.

5. The method according to claim 4, wherein the resin comprises phenolic resin.

6. The method according to claim 4, wherein the resin comprises liquid resin, the method further comprising:
crosslinking the liquid resin with a curing agent when the porous filler is impregnated with the liquid resin.

7. The method according to claim 4, wherein the resin comprises liquid resin, the method further comprising:
crosslinking the liquid resin by self-crosslinking when the porous filler is impregnated with the liquid resin.

8. The method according to claim 4, wherein the resin comprises liquid resin, the method further comprising:
crosslinking the liquid resin with a curing agent, after the step of impregnating.

9. The method according to claim 4, wherein the resin comprises liquid resin, the method further comprising:
crosslinking the liquid resin by self-crosslinking, after the step of impregnating.

10. A resin-impregnated porous filler comprising:
layers of a stratified clay mineral;
a coupling agent or an inorganic material inserted between the layers;
meso-pores, micro-pores, and macro-pores; and
resin impregnating in the macro-pores.

11. A friction material comprising:
a resin-impregnated porous filler including:
layers of a stratified clay mineral;
a coupling agent or an inorganic material inserted between the layers;
meso-pores, micro-pores, and macro-pores; and
resin impregnating in the macro-pores.
